(19) United States
(12) Patent Application Publication
(10) Pub. No.: US 2016/0217721 A1
(43) Pub. Date: Jul. 28, 2016

(54) INFORMATION PROCESSING SYSTEM, TERMINAL APPARATUS, INFORMATION PROCESSING APPARATUS, INFORMATION PROCESSING METHOD

(71) Applicant: KYOCERA Document Solutions Inc., Osaka (JP)

(72) Inventor: Kenta Nakatsu, Osaka (JP)

(21) Appl. No.: 15/004,383

(22) Filed: Jan. 22, 2016

(30) Foreign Application Priority Data
Jan. 26, 2015 (JP) 2015-012393

(51) Int. Cl. G09G 3/00; G06F 17/24; G06F 17/22; G06F 3/0488; G06F 3/0483

(52) U.S. Cl. CPC G09G 3/008; G06F 3/04883; G06F 3/0483; G06F 17/2205; G06F 17/242

(57) ABSTRACT

An information processing system includes information processing apparatus and terminal apparatus that includes display portion and operation portion. A first display processing portion displays electronic teaching material on the display portion. A switch processing portion switches page of electronic teaching material displayed on display portion in response to switch operation performed to operation portion. A page information obtaining portion, in response to switch operation, obtains page information corresponding to page of electronic teaching material that had been displayed before being switched. A board-written data obtaining portion obtains lesson information that is input to board surface, as board-written data. A storage processing portion stores page information into storage portion in association with one or more pieces of board-written data that had been obtained by board-written data obtaining portion before the page information was obtained by page information obtaining portion.

### INCORPORATION BY REFERENCE

This application is based upon and claims the benefit of priority from the corresponding Japanese Patent Application No. 2015-012393 filed on Jan. 26, 2015, the entire contents of which are incorporated herein by reference.

### BACKGROUND

The present disclosure relates to an information processing system, to a terminal apparatus and an information processing apparatus included in the information processing system, and to an information processing method.

At the site of education such as a school, a lesson may be conducted by using an interactive whiteboard and tablet terminals. The interactive whiteboard is configured to obtain, as board-written data, information (hereinafter referred to as “lesson information”) such as characters and graphics written by the teacher on a board surface during the lesson. Terminal apparatuses such as tablet terminals are distributed to and used by the students. For example, the terminal apparatuses may obtain an electronic teaching material which has been digitized from a teaching material such as a textbook, from a server, and display the obtained electronic teaching material on the displays of the terminal apparatuses. This enables the students to refer to the electronic teaching material displayed on the terminal apparatuses during the lesson. On the other hand, the interactive whiteboard periodically obtains, as the board-written data, the lesson information written on the board surface by the teacher during the lesson, and stores the obtained board-written data in the server. The board-written data stored in the server is used by the teacher to improve the lesson content, or used by the students to review the lesson.

### SUMMARY

An information processing system according to an aspect of the present disclosure includes a terminal apparatus and an information processing apparatus. The terminal apparatus includes a display portion and an operation portion. The information processing system includes a first display processing portion, a switch processing portion, a page information obtaining portion, a board-written data obtaining portion, and a storage processing portion. The first display processing portion displays an electronic teaching material on the display portion. The switch processing portion switches a page of the electronic teaching material displayed on the display portion in response to a switch operation performed to the operation portion. The page information obtaining portion, in response to the switch operation, obtains page information that corresponds to the page of the electronic teaching material that had been displayed before being switched by the switch processing portion. The board-written data obtaining portion obtains lesson information that is input to a board surface, as board-written data. The storage processing portion stores the page information obtained by the page information obtaining portion into a storage portion in association with one or more pieces of board-written data that had been obtained by the board-written data obtaining portion before the page information was obtained by the page information obtaining portion.

A terminal apparatus according to another aspect of the present disclosure includes a display portion and an operation portion, a first display processing portion, a switch processing portion, a page information obtaining portion, and a page information transmitting portion. The first display processing portion displays an electronic teaching material on the display portion. The switch processing portion switches a page of the electronic teaching material displayed on the display portion in response to a switch operation performed to the operation portion. The page information obtaining portion, in response to the switch operation, obtains page information that corresponds to the page of the electronic teaching material that had been displayed before being switched by the switch processing portion. The page information transmitting portion transmits, to an information processing apparatus, the page information obtained by the page information obtaining portion.

An information processing apparatus according to a further aspect of the present disclosure includes a page information receiving portion, a board-written data obtaining portion, and a storage processing portion. The page information receiving portion receives, from a terminal apparatus, page information that corresponds to a page of an electronic teaching material displayed on a display portion of the terminal apparatus. The board-written data obtaining portion obtains lesson information that is input to a board surface, as board-written data. The storage processing portion stores the page information received by the page information receiving portion into a storage portion in association with one or more pieces of board-written data that had been received by the board-written data receiving portion before the page information was received by the page information receiving portion.

An information processing method according to a still further aspect of the present disclosure is performed in an information processing system which includes a terminal apparatus and an information processing apparatus. The terminal apparatus includes a display portion and an operation portion. The information processing method includes the following first to fifth steps. In the first step, an electronic teaching material is displayed on the display portion. In the second step, a page of the electronic teaching material displayed on the display portion is switched in response to a switch operation performed to the operation portion. In the third step, in response to the switch operation, page information that corresponds to the page of the electronic teaching material that had been displayed before being switched in the second step is obtained. In the fourth step, lesson information that is input to a board surface is obtained as board-written data. In the fifth step, the page information obtained in the third step is stored into a storage portion in association with one or more pieces of board-written data that had been obtained in the fourth step before the page information was obtained in the third step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing the configuration of an information processing system according to an embodiment of the present disclosure.

FIG. 2 is a diagram showing the configuration of an interactive whiteboard included in the information processing system according to an embodiment of the present disclosure.

FIG. 3 is a flowchart showing an example of a page information storing process executed in a server included in the information processing system according to an embodiment of the present disclosure.

FIG. 4 is a flowchart showing an example of a board-written data obtaining process executed in the interactive whiteboard included in the information processing system according to an embodiment of the present disclosure.

FIG. 5 is a flowchart showing an example of a page information obtaining process executed in terminal apparatuses included in the information processing system according to an embodiment of the present disclosure.

FIG. 6 is a flowchart showing an example of a lesson information display process executed in the terminal apparatuses included in the information processing system according to an embodiment of the present disclosure.

### DETAILED DESCRIPTION

The following describes an embodiment of the present disclosure with reference to the drawings. It should be noted that the following embodiment is an example of a specific embodiment of the present disclosure and should not limit the technical scope of the present disclosure.

[Information Processing System 100]

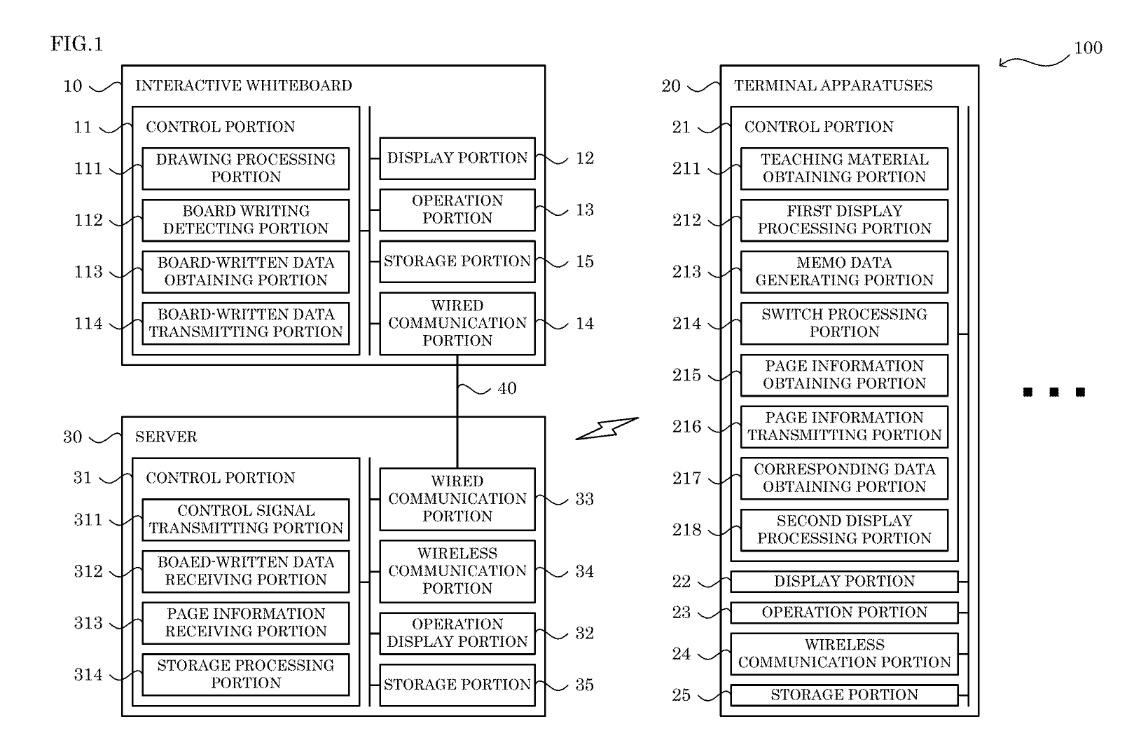

First, the configuration of an information processing system 100 according to an embodiment of the present disclosure is described with reference to FIG. 1. Here, FIG. 1 is a block diagram showing the configuration of the information processing system 100.

As shown in FIG. 1, the information processing system 100 includes an interactive whiteboard 10, one or more terminal apparatuses 20, and a server 30. The interactive whiteboard 10 and the server 30 are connected via a communication network 40 such as the Internet or a LAN, and can perform wired data communications with each other. The terminal apparatuses 20 and the server 30 can perform wireless data communications with each other. It is noted that the interactive whiteboard 10 and the server 30 may be able to perform wireless data communications with each other. In addition, the terminal apparatuses 20 and the server 30 may be connected via the communication network 40. Here, the interactive whiteboard 10 and the server 30 are an example of the information processing apparatus of the present disclosure. It is noted that the present disclosure can also be realized by the information processing system 100 in which the server 30 is omitted and the components of the server 30 are included in the interactive whiteboard 10.

[Interactive Whiteboard 10]

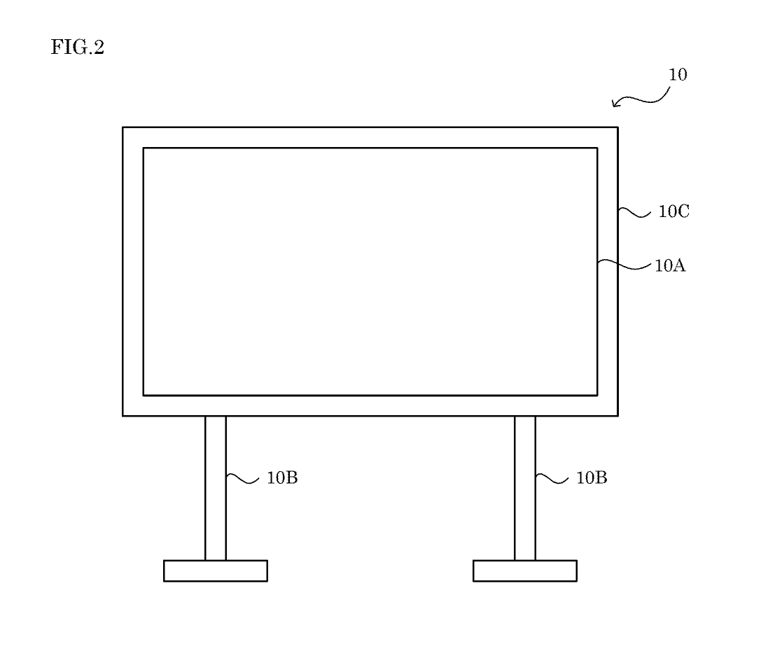

Next, the configuration of the interactive whiteboard 10 is described with reference to FIG. 1 and FIG. 2. Here, FIG. 2 is a schematic diagram showing the configuration of the interactive whiteboard 10.

The interactive whiteboard 10 is configured to obtain, as board-written data, information (hereinafter referred to as “lesson information”) such as characters and graphics written on a board surface 10A shown in FIG. 2. As shown in FIG. 2, the outer circumference of the board surface 10A is surrounded by a frame 10C that is supported by leg portions 10B.

Specifically, as shown in FIG. 1, the interactive whiteboard 10 includes a control portion 11, a display portion 12, an operation portion 13, a wired communication portion 14, and a storage portion 15.

The control portion 11 includes control equipment such as CPU, ROM, and RAM that are not shown. The CPU is a processor that executes various calculation processes. The ROM is a nonvolatile storage medium in which various information such as control programs for causing the CPU to execute various processes are stored in advance. The RAM is a volatile storage medium, and is used as a temporary storage memory (working area) for the various processes executed by the CPU. In the control portion 11, the CPU executes the various control programs stored in advance in the ROM or the like. This allows the interactive whiteboard 10 to be controlled comprehensively by the control portion 11.

The display portion 12 displays various types of information on the board surface 10A based on control instructions from the control portion 11. That is, the board surface 10A is a display surface of the display portion 12. For example, the display portion 12 is a liquid crystal display.

The operation portion 13 inputs various types of information to the control portion 11 in response to user operations performed on the board surface 10A. For example, the operation portion 13 is a touch panel provided on the board surface 10A.

The wired communication portion 14 is a communication interface that can perform a wired data communication with an external communication apparatus such as the server 30 via the communication network 40.

The storage portion 15 is a storage device such as SSD (Solid State Drive) or HDD (Hard Disk Drive). It is noted that the storage portion 15 may be the RAM of the control portion 11.

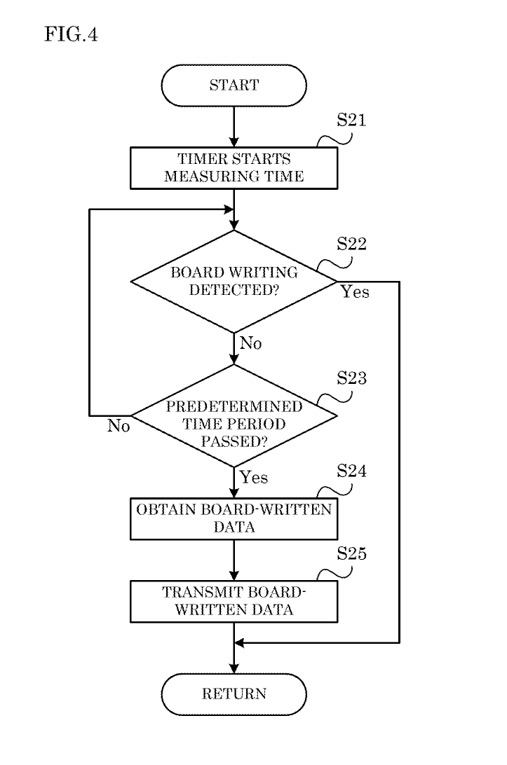

A board-written data obtaining program is stored in the storage portion 15 in advance, wherein the board-written data obtaining program causes the CPU of the control portion 11 to execute a board-written data obtaining process (see the flowchart of FIG. 4) that is described below. It is noted that the board-written data obtaining program may be recorded on a computer-readable recording medium such as a CD, a DVD, or a flash memory, and may be installed from the recording medium to the storage portion 15.

As shown in FIG. 1, the control portion 11 includes a drawing processing portion 111, a board writing detecting portion 112, a board-written data obtaining portion 113, and a board-written data transmitting portion 114. Specifically, the CPU of the control portion 11 executes the board-written data obtaining program stored in the storage portion 15. This allows the control portion 11 to function as the drawing processing portion 111, the board writing detecting portion 112, the board-written data obtaining portion 113, and the board-written data transmitting portion 114.

The drawing processing portion 111, in response to a signal that is input from the operation portion 13 in correspondence with a drawing operation performed on the board surface 10A, renders an image on the display portion 12 in correspondence with the drawing operation. This allows the lesson information such as the characters and graphics to be displayed on the board surface 10A.

The board writing detecting portion 112 detects whether or not there has been board writing on the board surface 10A. That is, the board writing detecting portion 112 detects whether or not a lesson information input operation has been performed on the board surface 10A. Specifically, the board writing detecting portion 112 detects whether or not there has been board writing on the board surface 10A, based on the signal that is input from the operation portion 13 in correspondence with the drawing operation performed on the board surface 10A.

The board-written data obtaining portion 113 obtains at predetermined timings, lesson information that is input to the board surface 10A, as board-written data. Here, the lesson information is not limited to what is input to the board surface 10A by a drawing operation, but may be what is drawn and input to the board surface 10A by a physical means using a chalk or the like. In addition, the board-written data obtaining portion 113 may cause an image reading portion such as a scanner that can read an image on the board surface 10A, to read the lesson information input to the board surface 10A, and obtain the read image data as the board-written data.

For example, the board-written data obtaining portion 113 may generate a screen shot of a display screen displayed on the board surface 10A by the display portion 12, and obtain the screen shot as the board-written data. It is noted that the board-written data obtaining portion 113 may generate difference data representing a difference between a current screen shot and a most recently generated screen shot, and obtain the difference data as the board-written data.

Here, the board-written data obtaining portion 113 obtains the board-written data each time a predetermined time passes after the board writing detecting portion 112 detects absence of board writing. It is noted that the board-written data obtaining portion 113 may obtain the board-written data each time a predetermined operation is performed to the operation portion 13, or each time a predetermined time passes.

The board-written data transmitting portion 114 transmits, to the server 30, the board-written data obtained by the board-written data obtaining portion 113. The board-written data transmitted to the server 30 is stored in a storage portion 35 of the server 30.

Meanwhile, at the site of education such as a school, a lesson may be conducted by using the interactive whiteboard 10 and the terminal apparatuses 20. The terminal apparatuses 20 are distributed to and used by the students. For example, the terminal apparatuses 20 may obtain an electronic teaching material which has been digitized from a teaching material such as a textbook, from the server 30, and display the obtained electronic teaching material on display portions 22 of the terminal apparatuses 20. This enables the students to refer to the electronic teaching material displayed on the terminal apparatuses 20 during the lesson. On the other hand, the interactive whiteboard 10 periodically obtains, as the board-written data, the lesson information written on the board surface 10A by the teacher during the lesson, and stores the obtained board-written data in a storage portion 35 of the server 30. The board-written data stored in the storage portion 35 of the server 30 is, for example, used by the teacher to improve the lesson content, or used by the students to review the lesson.

Here, in a case where students review the lesson by using the board-written data stored in the server 30, it is preferable, from the viewpoint of improving the learning effects, that a page of the electronic teaching material that the students were referring to during the lesson and the lesson information that was written by the teacher on the board surface 10A of the interactive whiteboard 10 while the students were referring to the page of the electronic teaching material, are both referred to by the students. However, conventionally, it is troublesome for the students to detect, from among a lot of pieces of board-written data stored in the storage portion 35 of the server 30, a piece of board-written data that corresponds to a specific page of the electronic teaching material, and it is difficult for the students to detect a desired piece of board-written data. On the other hand, in the information processing system 100 of the present disclosure, in a case where a lesson is conducted by using the interactive whiteboard 10 and the terminal apparatuses 20, it is possible to reduce the trouble of the students when they review the lesson.

The following describes the terminal apparatuses 20 and the server 30 with reference to FIG. 1.

[Terminal Apparatuses 20]

As shown in FIG. 1, the terminal apparatuses 20 is an information processing apparatus such as a tablet terminal including a control portion 21, a display portion 22, an operation portion 23, a wireless communication portion 24, and a storage portion 25. It is noted that the terminal apparatuses 20 may be a personal computer, a PDA, or a smartphone.

The control portion 21 includes control equipment such as CPU, ROM, and RAM that are not shown. The CPU is a processor that executes various calculation processes. The ROM is a nonvolatile storage medium in which various information such as control programs for causing the CPU to execute various processes are stored in advance. The RAM is a volatile storage medium, and is used as a temporary storage memory (working area) for the various processes executed by the CPU. In the control portion 21, the CPU executes the various control programs stored in advance in the ROM or the like. This allows the terminal apparatuses 20 to be controlled comprehensively by the control portion 21.

The display portion 22 displays various types of information based on control instructions from the control portion 21. For example, the display portion 22 is a liquid crystal display.

The operation portion 23 inputs various types of information to the control portion 21 in response to user operations. For example, the operation portion 23 is a touch panel provided on the display surface of the display portion 22 and can input various types of information to the control portion 21 based on user operations performed on the display surface.

The wireless communication portion 24 is a communication interface that can perform a wireless data communication with an external communication apparatus such as the server 30.

The storage portion 25 is a storage device such as SSD (Solid State Drive) or HDD (Hard Disk Drive). It is noted that the storage portion 25 may be the RAM of the control portion 21.

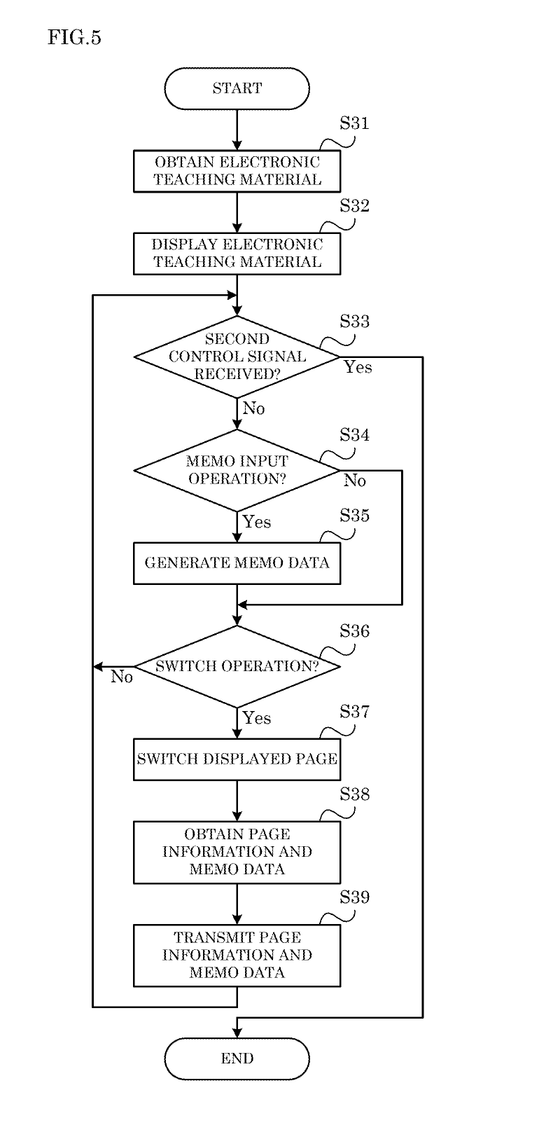

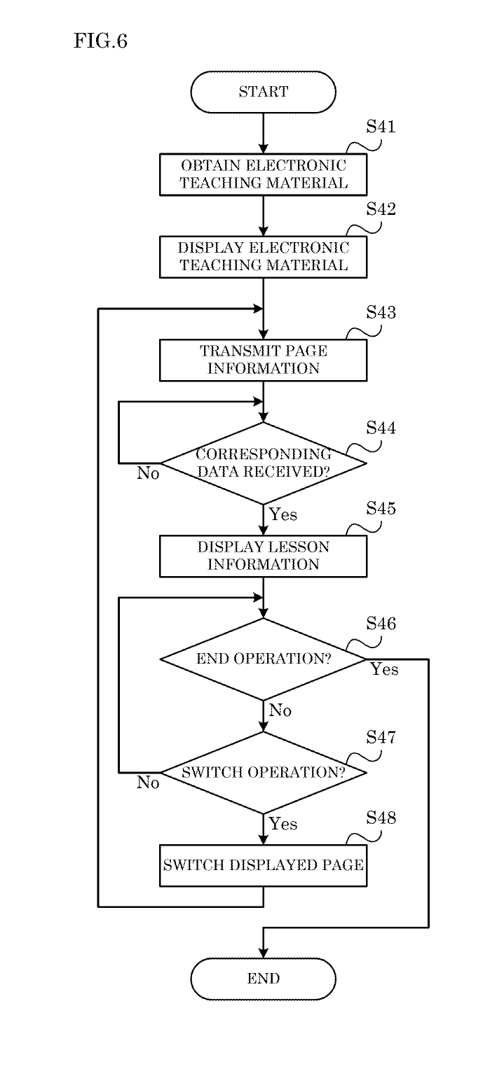

A page information obtaining program is stored in the storage portion 25 in advance, wherein the page information obtaining program causes the CPU of the control portion 21 to execute a page information obtaining process (see the flowchart of FIG. 5) and a lesson information display process (see the flowchart of FIG. 6) that are described below. It is noted that the page information obtaining program may be recorded on a computer-readable recording medium such as a CD, a DVD, or a flash memory, and may be installed from the recording medium to the storage portion 25.

As shown in FIG. 1, the control portion 21 includes a teaching material obtaining portion 211, a first display processing portion 212, a memo data generating portion 213, a switch processing portion 214, a page information obtaining portion 215, a page information transmitting portion 216, a corresponding data obtaining portion 217, and a second display processing portion 218. Specifically, the CPU of the control portion 21 executes the page information obtaining program stored in the storage portion 25. This allows the control portion 21 to function as the teaching material obtaining portion 211, the first display processing portion 212, the memo data generating portion 213, the switch processing portion 214, the page information obtaining portion 215, the page information transmitting portion 216, the corresponding data obtaining portion 217, and the second display processing portion 218.

The teaching material obtaining portion 211 obtains the electronic teaching material which has been digitized from a teaching material such as a textbook. The teaching material includes books such as textbooks, as well as prints and booklets in which learning items of the lesson and the like are described. The electronic teaching material is stored in the storage portion 35 of the server 30 in advance. As one example, the teaching material obtaining portion 211 causes the server 30 to transmit the electronic teaching material by transmitting, to the server 30, an instruction to transmit the electronic teaching material. The teaching material obtaining portion 211 then receives and obtains the electronic teaching material transmitted from the server 30. It is noted that the electronic teaching material may be stored in the storage portion 25 in advance.

The first display processing portion 212 displays, on the display portion 22, the electronic teaching material obtained by the teaching material obtaining portion 211. Specifically, the first display processing portion 212 displays a predetermined page of the electronic teaching material on the display portion 22. For example, the first display processing portion 212 displays, on the display portion 22, a page of the electronic teaching material that has been set in the server 30 in advance based on the content of the lesson to be conducted using the information processing system 100.

The memo data generating portion 213 generates memo data representing a memo in response to a memo input operation performed on the page of the electronic teaching material displayed on the display portion 22. For example, the memo data generating portion 213, in response to a tap operation performed on the page of the electronic teaching material displayed on the display portion 22, displays, on the display portion 22, a memo input screen for performing a memo input operation. The memo data generating portion 213 then generates the memo data based on the memo input operation performed on the memo input screen.

The switch processing portion 214 switches the page of the electronic teaching material displayed on the display portion 22 in response to a switch operation performed to the operation portion 23. For example, the switch operation is a swipe operation performed on the display surface of the display portion 22.

The page information obtaining portion 215, in response to the switch operation, obtains page information that corresponds to the page of the electronic teaching material that had been displayed before being switched by the switch processing portion 214. In addition, the page information obtaining portion 215 obtains, together with the page information, the memo data generated by the memo data generating portion 213 which corresponds to the page of the electronic teaching material that had been displayed before being switched by the switch processing portion 214.

The page information transmitting portion 216 transmits, to the server 30, the page information and the memo data obtained by the page information obtaining portion 215. In addition, the page information transmitting portion 216 transmits identification information of the terminal apparatuses 20 to the server 30 together with the page information and the memo data.

The corresponding data obtaining portion 217 obtains one or more pieces of board-written data corresponding to the page of the electronic teaching material displayed on the display portion 22. In addition, the corresponding data obtaining portion 217 obtains, together with the board-written data, the memo data corresponding to the page of the electronic teaching material displayed on the display portion 22.

Specifically, the corresponding data obtaining portion 217 causes the server 30 to transmit the board-written data and the memo data corresponding to the page of the electronic teaching material by transmitting, to the server 30, a transmission instruction together with the identification information and the page information corresponding to the page of the electronic teaching material displayed on the display portion 22, the transmission instruction instructing to transmit the board-written data and the memo data corresponding to the page of the electronic teaching material. The corresponding data obtaining portion 217 then receives and obtains the board-written data and the memo data transmitted from the server 30.

The second display processing portion 218 displays the lesson information on the display portion 22 based on the board-written data obtained by the corresponding data obtaining portion 217. In addition, the second display processing portion 218 displays a memo together with the lesson information on the display portion 22 based on the memo data obtained by the corresponding data obtaining portion 217. For example, the second display processing portion 218 displays a thumbnail image representing the lesson information and the memo on the page of the electronic teaching material displayed on the display portion 22. It is noted that the second display processing portion 218 may display the lesson information and the memo in response to a predetermined operation such as a tap operation performed on the page of the electronic teaching material displayed on the display portion 22.

[Server 30]

As shown in FIG. 1, the server 30 is an information processing apparatus including a control portion 31, an operation display portion 32, a wired communication portion 33, a wireless communication portion 34, and a storage portion 35.

The control portion 31 includes control equipment such as CPU, ROM, and RAM that are not shown. The CPU is a processor that executes various calculation processes. The ROM is a nonvolatile storage medium in which various information such as control programs for causing the CPU to execute various processes are stored in advance. The RAM is a volatile storage medium, and is used as a temporary storage memory (working area) for the various processes executed by the CPU. In the control portion 31, the CPU executes the various control programs stored in advance in the ROM or the like. This allows the server 30 to be controlled comprehensively by the control portion 31.

The operation display portion 32 includes a display portion and an operation portion, wherein the display portion is a liquid crystal display or the like that displays various types of information based on control instructions from the control portion 31, and the operation portion includes, for example, a keyboard and a mouse for receiving various input operations of the user.

The wired communication portion 33 is a communication interface that can perform a wired data communication with an external communication apparatus such as the interactive whiteboard 10 via the communication network 40.

The wireless communication portion 34 is a communication interface that can perform a wireless data communication with external communication apparatuses such as the terminal apparatuses 20.

The storage portion 35 is a storage device such as SSD (Solid State Drive) or HDD (Hard Disk Drive). The electronic teaching material is stored in the storage portion 35 in advance. It is noted that the storage portion 35 may be the RAM of the control portion 31.

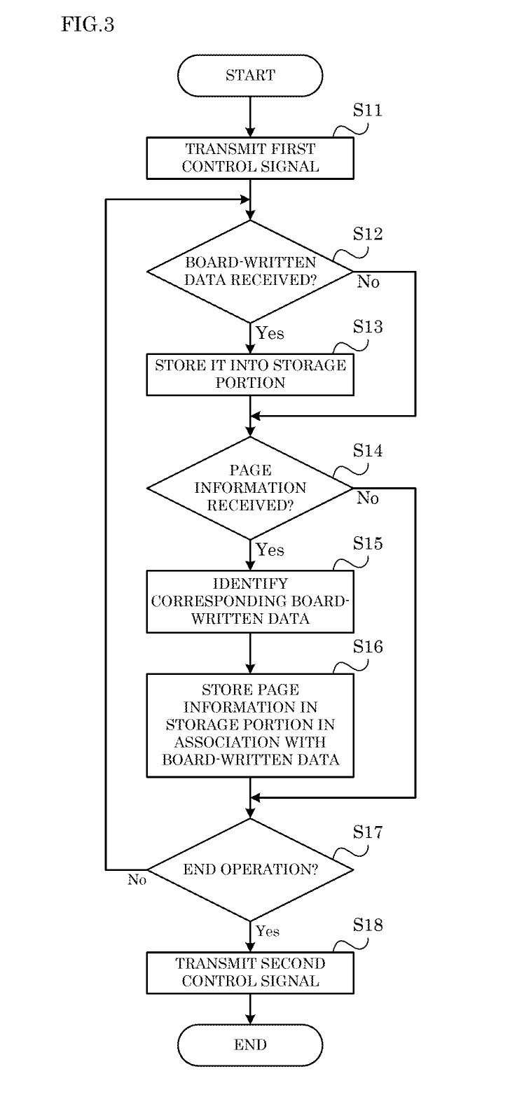

A page information storing program is stored in the storage portion 35 in advance, wherein the page information storing program causes the CPU of the control portion 31 to execute a page information storing process (see the flowchart of FIG. 3) that is described below. It is noted that the page information storing program may be recorded on a computer-readable recording medium such as a CD, a DVD, or a flash memory, and may be installed from the recording medium to the storage portion 35.

As shown in FIG. 1, the control portion 31 includes a control signal transmitting portion 311, a board-written data receiving portion 312, a page information receiving portion 313, and a storage processing portion 314. Specifically, the CPU of the control portion 31 executes the page information storing program stored in the storage portion 35. This allows the control portion 31 to function as the control signal transmitting portion 311, the board-written data receiving portion 312, the page information receiving portion 313, and the storage processing portion 314.

The control signal transmitting portion 311 transmits, to the interactive whiteboard 10 and the terminal apparatuses 20, a first control signal that indicates the start of a lesson. Upon receiving the first control signal, the interactive whiteboard 10 and the terminal apparatuses 20 execute processes corresponding to the start of the lesson. Specifically, upon receiving the first control signal, the interactive whiteboard 10 executes a board-written data obtaining process that is described below, and the terminal apparatuses 20 execute a page information obtaining process that is described below.

The control signal transmitting portion 311 also transmits, to the interactive whiteboard 10 and the terminal apparatuses 20, a second control signal that indicates the end of the lesson. Upon receiving the second control signal, the interactive whiteboard 10 and the terminal apparatuses 20 end the processes that were started upon reception of the first control signal.

The board-written data receiving portion 312 receives the board-written data transmitted from the interactive whiteboard 10 and stores the received board-written data in the storage portion 35.

The page information receiving portion 313 receives the page information transmitted from the terminal apparatuses 20. In addition, the page information receiving portion 313 receives the identification information and the memo data that are transmitted together with the page information from the terminal apparatuses 20.

The storage processing portion 314 stores each piece of page information received by the page information receiving portion 313 into the storage portion 35 in association with one or more pieces of board-written data that had been received by the board-written data receiving portion 312 before the piece of page information was received by the page information receiving portion 313. Specifically, the storage processing portion 314 stores, into the storage portion 35, the piece of page information in association with the one or more pieces of board-written data and in association with a terminal apparatus 20 which is identified by the identification information received by the page information receiving portion 313 together with the piece of page information. In addition, the storage processing portion 314 stores, in association with the piece of page information, the memo data that was received by the page information receiving portion 313 together with the piece of page information.

Next, a description is given of the processes executed in the information processing system 100, namely, the page information storing process executed in the server 30, the board-written data obtaining process executed in the interactive whiteboard 10, and the page information obtaining process and the lesson information display process executed in the terminal apparatuses 20.

[Page Information Storing Process]

First, a description is given of an example of the procedure of the page information storing process executed by the CPU of the control portion 31 in the server 30, with reference to FIG. 3. Here, steps S11, S12, . . . represent numbers assigned to the processing procedures (steps) executed by the control portion 31. It is noted that the control portion 31 executes the page information storing process when an operation for instructing an execution of the page information storing process is performed on the operation display portion 32. For example, the operation for instructing an execution of the page information storing process is performed by a teacher when he/she starts a lesson.

<Step S11>

First, in step S11, the control portion 31 transmits the first control signal to the interactive whiteboard 10 and the terminal apparatuses 20. Here, the process of step S11 is executed by the control signal transmitting portion 311 of the control portion 31.

<Step S12>

In step S12, the control portion 31 determines whether or not the board-written data has been received from the interactive whiteboard 10.

Upon determining that the board-written data has been received from the interactive whiteboard 10 (Yes side at S12), the control portion 31 moves the process to step S13. In addition, upon determining that the board-written data has not been received from the interactive whiteboard 10 (No side at S12), the control portion 31 moves the process to step S14.

<Step S13>

In step S13, the control portion 31 stores the board-written data received in step S12, into the storage portion 35. Here, processes of step S12 and step S13 are executed by the board-written data receiving portion 312 of the control portion 31.

<Step S14>

In step S14, the control portion 31 determines whether or not the page information and the identification information have been received from the terminal apparatuses 20.

Upon determining that the page information and the identification information have been received from the terminal apparatuses 20 (Yes side at S14), the control portion 31 moves the process to step S15. In addition, upon determining that the page information and the identification information have not been received from the terminal apparatuses 20 (No side at S14), the control portion 31 moves the process to step S17. Here, process of step S14 is executed by the page information receiving portion 313 of the control portion 31.

<Step S15>

In step S15, the control portion 31 identifies one or more pieces of board-written data that were stored in the storage portion 35 in step S13.

For example, the control portion 31 identifies, from among a plurality of pieces of board-written data stored in the storage portion 35, one or more pieces of board-written data that were stored in the storage portion 35 between the start of the page information storing process and the determination in step S14 that the page information and the identification information had been received.

<Step S16>

In step S16, the control portion 31 stores the page information determined in step S14 to have been received, into the storage portion 35 in association with the board-written data identified in step S15. For example, the control portion 31 associates the page information with the board-written data by attaching data identification information that identifies the board-written data identified in step S15, to the page information. Here, processes of step S15 and step S16 are an example of the fifth step of the present disclosure and executed by the storage processing portion 314 of the control portion 31.

Here, the control portion 31 stores the page information into the storage portion 35 in association with the board-written data and in association with a terminal apparatus identified by the identification information that was determined in step S14 to have been received. In addition, if the memo data is determined in step S14 to have been received together with the page information, the control portion 31 stores the memo data in association with the page information, into the storage portion 35.

<Step S17>

In step S17, the control portion 31 determines whether or not an operation for ending the page information storing process was performed on the operation display portion 32.

Upon determining that the operation for ending the page information storing process was performed on the operation display portion 32 (Yes side at S17), the control portion 31 moves the process to step S18. In addition, upon determining that the operation for ending the page information storing process has not been performed on the operation display portion 32 (No side at S17), the control portion 31 moves the process to step S12. This allows the processes from step S12 to step S16 to be executed repeatedly until the operation for ending the page information storing process is performed. It is noted that in step S15 of the second round and after, the control portion 31 identifies, from among the plurality of pieces of board-written data stored in the storage portion 35, one or more pieces of board-written data determined in step S12 to have been received between the preceding execution and the present execution of step S14.

<Step S18>

In step S18, the control portion 31 transmits the second control signal to the interactive whiteboard 10 and the terminal apparatuses 20. Here, the process of step S18 is executed by the control signal transmitting portion 311 of the control portion 31.

[Board-Written Data Obtaining Process]

Next, a description is given of an example of the procedure of the board-written data obtaining process executed by the control portion 11 in the interactive whiteboard 10, with reference to FIG. 4. It is noted that, upon receiving the first control signal transmitted from the server 30, the control portion 11 executes the board-written data obtaining process. In addition, upon receiving the second control signal transmitted from the server 30, the control portion 11 ends the board-written data obtaining process.

<Step S21>

First, in step S21, the control portion 11 causes a timer to start measuring the time.

<Step S22>

In step S22, the control portion 11 determines whether or not a board writing on the board surface 10A has been detected. That is, the control portion 11 determines whether or not the lesson information has been input to the board surface 10A.

Here, upon determining that a board writing on the board surface 10A has been detected (Yes side at S22), the control portion 11 resets the time measurement started in step S21 and moves the process to step S21. In addition, upon determining that a board writing on the board surface 10A has not been detected (No side at S22), the control portion 11 moves the process to step S23.

<Step S23>

In step S23, the control portion 11 determines whether or not a predetermined time period has passed since the start of the time measurement in step S21.

Here, upon determining that the predetermined time period has passed since the start of the time measurement in step S21 (Yes side at S23), the control portion 11 moves the process to step S24. In addition, upon determining that the predetermined time period has not passed since the start of the time measurement in step S21 (No side at S23), the control portion 11 moves the process to step S22 and waits for detection of a board writing on the board surface 10A or passage of the predetermined time period.

<Step S24>

In step S24, the control portion 11 obtains, as the board-written data, the lesson information displayed on the board surface 10A. For example, the control portion 11 generates a screen shot of a display screen displayed on the board surface 10A by the display portion 12, and obtains the screen shot as the board-written data. Here, the process of step S24 is an example of the fourth step of the present disclosure, and is executed by the board-written data obtaining portion 113 of the control portion 11. It is noted that the control portion 11 may execute the process of step S24 when a predetermined operation is performed on the operation portion 13 even if the predetermined time period has not passed since the start of the time measurement in step S21.

<Step S25>

In step S25, the control portion 11 transmits the board-written data obtained in step S24 to the server 30.

[Page Information Obtaining Process]

Next, a description is given of an example of the procedure of the page information obtaining process executed by the CPU of the control portion 21 in the terminal apparatuses 20, with reference to FIG. 5. It is noted that, upon receiving the first control signal transmitted from the server 30, the control portion 21 executes the page information obtaining process.

<Step S31>

First, in step S31, the control portion 21 obtains the electronic teaching material. For example, the control portion 21 causes the server 30 to transmit the electronic teaching material by transmitting, to the server 30, an instruction to transmit the electronic teaching material. The control portion 21 then receives and obtains the electronic teaching material transmitted from the server 30. Here, the process of step S31 is executed by the teaching material obtaining portion 211 of the control portion 21.

<Step S32>

In step S32, the control portion 21 displays, on the display portion 22, the electronic teaching material obtained in step S31. For example, the control portion 21 displays, on the display portion 22, a page of the electronic teaching material that has been set in the server 30 in advance. Here, the process of step S32 is an example of the first step of the present disclosure, and is executed by the first display processing portion 212 of the control portion 21.

<Step S33>

In step S33, the control portion 21 determines whether or not the second control signal has been received from the server 30.

Here, upon determining that the second control signal has been received from the server 30 (Yes side at S33), the control portion 21 ends the page information obtaining process. In addition, upon determining that the second control signal has not been received from the server 30 (No side at S33), the control portion 21 moves the process to step S34.

<Step S34>

In step S34, the control portion 21 determines whether or not a memo input operation has been performed on the page of the electronic teaching material displayed on the display portion 22. Specifically, in response to a tap operation performed on the page of the electronic teaching material displayed on the display portion 22, the control portion 21 displays, on the display portion 22, a memo input screen for performing a memo input operation. The control portion 21 determines that a memo input operation has been performed when the memo input screen has received the memo input operation.

Here, upon determining that a memo input operation has been performed (Yes side at S34), the control portion 21 moves the process to step S35. In addition, upon determining that a memo input operation has not been performed (No side at S34), the control portion 21 moves the process to step S36.

<Step S35>

In step S35, in response to the memo input operation performed in step S34, the control portion 21 generates memo data representing the memo. Here, the processes of step S34 and step S35 are executed by the memo data generating portion 213 of the control portion 21.

<Step S36>

In step S36, the control portion 21 determines whether or not a switch operation has been performed on the operation portion 23.

Here, upon determining that a switch operation has been performed on the operation portion 23 (Yes side at S36), the control portion 21 moves the process to step S37. In addition, upon determining that a switch operation has not been performed on the operation portion 23 (No side at S36), the control portion 21 moves the process to step S33, and waits for a memo input operation to be performed or a switch operation to be performed on the operation portion 23 until the second control signal is received from the server 30.

<Step S37>

In step S37, the control portion 21 switches the page of the electronic teaching material displayed on the display portion 22. Here, the process of step S37 is an example of the second step of the present disclosure, and is executed by the switch processing portion 214 of the control portion 21.

<Step S38>

In step S38, the control portion 21 obtains page information that corresponds to the page of the electronic teaching material that had been displayed before being switched in step S37. In addition, the control portion 21 obtains, together with the page information, the memo data that corresponds to the page of the electronic teaching material that had been displayed before being switched. Here, the process of step S38 is an example of the third step of the present disclosure, and is executed by the page information obtaining portion 215 of the control portion 21.

<Step S39>

In step S39, the control portion 21 transmits, to the server 30, the page information and the memo data obtained in step S38, and the identification information. Here, the process of step S39 is executed by the page information transmitting portion 216 of the control portion 21.

[Lesson Information Display Process]

Next, a description is given of an example of the procedure of the lesson information display process executed by the CPU of the control portion 21 in the terminal apparatuses 20, with reference to FIG. 6. It is noted that the control portion 21 executes the lesson information display process when an operation for instructing an execution of the lesson information display process is performed on the operation portion 23. For example, the operation for instructing an execution of the lesson information display process is performed after the lesson ends by a student who has taken the lesson.

<Step S41>

First, in step S41, the control portion 21, as in the process of step S31 in the page information obtaining process, obtains the electronic teaching material.

<Step S42>

In step S42, the control portion 21, as in the process of step S32 in the page information obtaining process, displays, on the display portion 22, the electronic teaching material obtained in step S41.

<Step S43>

In step S43, the control portion 21, transmits, to the server 30, a transmission instruction instructing to transmit the board-written data and the memo data corresponding to the page of the electronic teaching material, together with the identification information and the page information corresponding to the page of the electronic teaching material displayed on the display portion 22.

On the other hand, upon receiving the page information, the identification information and the transmission instruction from the terminal apparatus 20, the control portion 31 of the server 30 obtains, from the storage portion 35, board-written data and memo data that correspond to the received page information. Specifically, the control portion 31 identifies and obtains the board-written data and the memo data that correspond to the received page information, based on the page information and the data identification information that are stored in the storage portion 35 for each of the terminal apparatuses 20. The control portion 31 then transmits the obtained board-written data and memo data to the terminal apparatus 20.

<Step S44>

In step S44, the control portion 21 determines whether or not the board-written data and the memo data that correspond to the page of the electronic teaching material have been received from the server 30.

Here, upon determining that the board-written data and the memo data have been received from the server 30 (Yes side at S44), the control portion 21 moves the process to step S45. In addition, upon determining that the board-written data and the memo data have not been received from the server 30 (No side at S44), the control portion 21, in step S44, waits for the board-written data and the memo data to be received from the server 30. Here, the processes of step S43 and step S44 are executed by the corresponding data obtaining portion 217 of the control portion 21.

<Step S45>

In step S45, the control portion 21 displays the lesson information on the display portion 22 based on the board-written data received in step S44. In addition, the control portion 21 displays, together with the lesson information, the memo on the display portion 22 based on the memo data received in step S44. For example, the control portion 21 displays thumbnail images representing the lesson information and the memo on the page of the electronic teaching material displayed on the display portion 22. Here, the process of step S45 is executed by the second display processing portion 218 of the control portion 21. With this configuration where a memo that was generated while an electronic teaching material was displayed on the display portion 22, is displayed together with lesson information, learning effects of the student who reviews the lesson by using the terminal apparatus 20 are improved.

<Step S46>

In step S46, the control portion 21 determines whether or not an operation for ending the lesson information display process was performed on the operation portion 23.

Here, upon determining that an operation for ending the lesson information display process was performed on the operation portion 23 (Yes side at S46), the control portion 21 ends the lesson information display process. In addition, upon determining that an operation for ending the lesson information display process has not been performed on the operation portion 23 (No side at S46), the control portion 21 moves the process to step S47.

<Step S47>

In step S47, the control portion 21, as in the process of step S36 in the page information obtaining process, determines whether or not a switch operation has been performed on the operation portion 23.

Here, upon determining that a switch operation has been performed on the operation portion 23 (Yes side at S47), the control portion 21 moves the process to step S48. In addition, upon determining that a switch operation has not been performed on the operation portion 23 (No side at S47), the control portion 21 moves the process to step S46, and waits for a switch operation to be performed on the operation portion 23 until an operation for ending the lesson information display process is performed.

<Step S48>

In step S48, the control portion 21, as in the process of step S37 in the page information obtaining process, switches the page of the electronic teaching material displayed on the display portion 22, in response to the switch operation determined to have been performed in step S47. Subsequently, the processes from step S43 are executed again such that the board-written data and the memo data corresponding to a page of the electronic teaching material to which the preceding page was switched in step S48 are obtained and displayed on the display portion 22.

As described above, in the information processing system 100, when a lesson is conducted by using the interactive whiteboard 10 and the terminal apparatuses 20, the page information storing process is executed in the server 30, the board-written data obtaining process is executed in the interactive whiteboard 10, and the page information obtaining process is executed in the terminal apparatuses 20. In this configuration, in the server 30, the page information that was transmitted from the terminal apparatuses 20 in response to the switch operation, is stored in the storage portion 35 in association with the board-written data transmitted from the interactive whiteboard 10 while the page of the electronic teaching material indicated by the page information was displayed. As a result, this configuration reduces a student's trouble of finding, from the storage portion 35 of the server 30, board-written data corresponding to lesson information that was written on the board surface 10A of the interactive whiteboard 10 by the teacher while the student was referring to a page of the electronic teaching material during a lesson, when the student reviews the lesson by using the board-written data stored in the storage portion 35 of the server 30.

In addition, in the lesson information display process executed in the terminal apparatuses 20, the lesson information which is based on the board-written data obtained in correspondence with the page of the electronic teaching material displayed on the display portions 22 of the terminal apparatuses 20, is automatically displayed on the display portion 22. This further reduces the students's trouble of reviewing the lesson.

### Other Embodiments

It is noted that the interactive whiteboard 10 of the information processing system 100 may not include the display portion 12, the drawing processing portion 111, and the board writing detecting portion 112. For example, the interactive whiteboard 10 may be configured such that the lesson information is input to the board surface 10A by a physical means such as a chalk. In that case, the board-written data obtaining portion 113 may cause an image reading portion such as a scanner that can read an image on the board surface 10A, to read the lesson information input to the board surface 10A provided on the interactive whiteboard 10, and obtain the board-written data.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system comprising at least one terminal apparatus and an information processing apparatus, the at least one terminal apparatus including a display portion and an operation portion, the information processing system comprising:
a first display processing portion configured to display an electronic teaching material on the display portion;
a switch processing portion configured to switch a page of the electronic teaching material displayed on the display portion in response to a switch operation performed to the operation portion;
a page information obtaining portion configured to, in response to the switch operation, obtain page information that corresponds to the page of the electronic teaching material that had been displayed before being switched by the switch processing portion;
a board-written data obtaining portion configured to obtain lesson information that is input to a board surface, as board-written data; and
a storage processing portion configured to store the page information obtained by the page information obtaining portion into a storage portion in association with one or more pieces of board-written data that had been obtained by the board-written data obtaining portion before the page information was obtained by the page information obtaining portion.

2. The information processing system according to claim 1 further comprising:
a corresponding data obtaining portion configured to obtain one or more pieces of board-written data corresponding to the page of the electronic teaching material displayed on the display portion; and
a second display processing portion configured to display the lesson information on the display portion based on the board-written data obtained by the corresponding data obtaining portion.

3. The information processing system according to claim 2 further comprising:
a memo data generating portion configured to generate memo data representing a memo in response to a memo input operation performed on the page of the electronic teaching material displayed on the display portion, wherein
the page information obtaining portion obtains, together with the page information, the memo data which corresponds to the page of the electronic teaching material that had been displayed before being switched by the switch processing portion,
the storage processing portion stores, into the storage portion, the memo data and the page information obtained by the page information obtaining portion, in association with each other,
the corresponding data obtaining portion obtains, together with the board-written data, the memo data corresponding to the page of the electronic teaching material displayed on the display portion, and
the second display processing portion displays the memo together with the lesson information on the display portion based on the memo data obtained by the corresponding data obtaining portion.

4. The information processing system according to claim 1, wherein
the at least one terminal apparatus includes the first display processing portion, the switch processing portion, the page information obtaining portion, and a page information transmitting portion configured to transmit, to the information processing apparatus, the page information obtained by the page information obtaining portion, and
the information processing apparatus includes the storage portion, a page information receiving portion configured to receive the page information transmitted from the at least one terminal apparatus, the board-written data obtaining portion, and the storage processing portion.

5. The information processing system according to claim 4, wherein
the at least one terminal apparatus is a plurality of terminal apparatuses,
the page information transmitting portion of each of the plurality of terminal apparatuses transmits, to the information processing apparatus, a piece of identification information of its associated terminal apparatus, together with a piece of page information, and
the storage processing portion stores, into the storage portion, a plurality of pieces of page information respectively in association with the plurality of terminal apparatuses that are respectively identified by a plurality of pieces of identification information each of which was transmitted together with the piece of page information.

6. The information processing system according to claim 1, wherein
the operation portion is a touch panel.

7. The information processing system according to claim 1 further comprising:
a board writing detecting portion configured to detect whether or not there has been board writing on the board surface, wherein
the board-written data obtaining portion obtains, as the board-written data, lesson information that is displayed on the board surface each time a predetermined time passes after the board writing detecting portion detects absence of board writing.

8. A terminal apparatus comprising:
a display portion and an operation portion;
a first display processing portion configured to display an electronic teaching material on the display portion;
a switch processing portion configured to switch a page of the electronic teaching material displayed on the display portion in response to a switch operation performed to the operation portion;
a page information obtaining portion configured to, in response to the switch operation, obtain page information that corresponds to the page of the electronic teaching material that had been displayed before being switched by the switch processing portion; and
a page information transmitting portion configured to transmit, to an information processing apparatus, the page information obtained by the page information obtaining portion.

9. An information processing apparatus comprising:
a page information receiving portion configured to receive, from a terminal apparatus, page information that corresponds to a page of an electronic teaching material displayed on a display portion of the terminal apparatus;
a board-written data obtaining portion configured to obtain lesson information that is input to a board surface, as board-written data; and
a storage processing portion configured to store the page information received by the page information receiving portion into a storage portion in association with one or more pieces of board-written data that had been received by the board-written data receiving portion before the page information was received by the page information receiving portion.

10. An information processing method performed in an information processing system which includes a terminal apparatus and an information processing apparatus, the terminal apparatus including a display portion and an operation portion, the information processing method comprising:
a first step of displaying an electronic teaching material on the display portion;
a second step of switching a page of the electronic teaching material displayed on the display portion in response to a switch operation performed to the operation portion;
a third step of obtaining, in response to the switch operation, page information that corresponds to the page of the electronic teaching material that had been displayed before being switched in the second step;
a fourth step of obtaining lesson information that is input to a board surface, as board-written data; and
a fifth step of storing the page information obtained in the third step into a storage portion in association with one or more pieces of board-written data that had been obtained in the fourth step before the page information was obtained in the third step.
